(19) United States
(12) Patent Application Publication
(10) Pub. No.: US 2013/0053989 A1
(43) Pub. Date: Feb. 28, 2013

(54) AUTOPILOT SIMULATION SYSTEM AND METHOD

(71) Applicant: Louis Edward Miller, Little Egg Harbor Twp, NJ (US)

(72) Inventor: Louis Edward Miller, Little Egg Harbor Twp, NJ (US)

(73) Assignee: CBS INTERACTIVE INC., San Francisco, CA (US)

(21) Appl. No.: 13/219,382

(22) Filed: Aug. 26, 2011

(51) Int. Cl. G06F 19/00

(52) U.S. Cl. 700/91

(57) ABSTRACT

A computer implemented method is described. A computer-implemented method provides determining if an extended absence flag has been triggered for a first participant. If the extended absence flag has been triggered, the computer-implemented method automatically performs one or more of a plurality of actions required to continue game play on behalf of the first participant as if the first participant was still actively involved in game play. By automatically conducting play of the first participant as if the first participant was still involved, the computer-implemented method maintains competitiveness as well as the game experience for other participants.

### BACKGROUND

Gaming applications are well known and becoming increasingly popular. In particular, certain types of simulation game experiences mimic or track real-life activities such as sports, hobbies, etc. These games are provided by computer applications hosted by local servers and/or by servers in the World Wide Web that allow users to participate on-line among a group of participants interested in the same type of simulation experience.

Generally, simulation games and in particular fantasy sports games, simulate real-life events where participants select players in various positions to form fantasy teams. A fantasy league consists of a plurality of these fantasy teams and consequently a number of these participants. Each fantasy team in the fantasy league usually competes against all the other teams in the fantasy league (head to head style) in scheduled matchups or accumulates statistics in chosen categories throughout the season (rotisserie style or ranked style). Success of a particular fantasy team in the fantasy league is determined by the cumulative number of points obtained by each of the fantasy players corresponding to the performance of the real-life players during the real-life athletic competitions. The fantasy team with the best won-lost record compiled during a fantasy season by the participant's fantasy team determines the winner.

Typically, real-life players from various teams within the given sport are drafted to create a roster for a particular fantasy team. Real-life players from different teams comprise a fantasy sports team. This drafting process may be performed via a bidding draft and/or a rotation draft. In a bidding draft, for example, each fantasy sport participant is initially provided with a specific bankroll of bidding units which may be used to bid against other participants in an attempt to obtain a specific real-life player to fill a fantasy team roster. In a rotation draft, the participants within a fantasy league determine an order of selection, and proceed through a number of rounds to fill out the roster of a particular number of players for each fantasy team. Once a player has been drafted by a participant to fill a roster of a fantasy team, that player is no longer available to other participants within the league. Therefore, each participant must reprioritize the available real-life players throughout the draft process.

As in professional sports, the fantasy league participants may trade players during the season for any one of a number of reasons. These trades are made between participants for fantasy players on other teams and/or from real-life players not selected in the initial draft by the participants within the fantasy sports league. A fantasy sports league typically corresponds to the length of the representative real-life sport with the potential exception of using a certain number of the final regular season games of the real life sports season as the playoffs and subsequent championship for the fantasy sports league.

During the course of a season, one or more participants may be absent for an extended period for vacation, business travel, etc. Currently, there is no mechanism for such participants to activate an extended absence trigger to indicate that the participant will be unable to participate in the fantasy competition(s) as well as the ongoing league season. In particular, when a participant takes a vacation or is otherwise unable to logon to the fantasy sports system, various actions requiring a response as well as trade and line-up deadlines must still be satisfied in order for the other participants in the league to continue game play. In addition, certain participants may decide to stop participating in the league for one of a number of reasons. In order to maintain competitiveness of the league as a whole as well as the game experience for the other participants still involved in the league and competing against the team of the disinterested participant, there is a need to continue management of game play of the disinterested participant's team. It is with respect to these and other considerations that the present improvements have been needed.

### BRIEF DESCRIPTION OF THE DRAWINGS

FIG. 1 illustrates a block diagram of a game system in accordance with an embodiment of the present disclosure.

FIG. 2 illustrates assistant general manager (“GM”) information and interfaces with the game module in accordance with an embodiment of the present disclosure.

FIG. 3 illustrates an embodiment of the assistant GM recommendation module in accordance with an embodiment of the present disclosure.

FIG. 4 illustrates an embodiment of a logic flow for triggering the autopilot module in accordance with an embodiment of the present disclosure.

FIG. 5 illustrates an embodiment of the autopilot module in accordance with an embodiment of the present disclosure.

FIG. 6 illustrates an embodiment of the autopilot scheduling module in accordance with an embodiment of the present disclosure.

FIG. 7 illustrates an embodiment of the autopilot action items module in accordance with an embodiment of the present disclosure.

FIG. 8 illustrates an embodiment of the autopilot event trigger module in accordance with an embodiment of the present disclosure.

FIG. 9 illustrates an embodiment of the autopilot lineup update module in accordance with an embodiment of the present disclosure.

FIGS. 10, 11A and 11B illustrate embodiments of a logic flow for game play in accordance with an embodiment of the present disclosure.

FIG. 12 illustrates an embodiment of a computing architecture.

FIG. 13 illustrates an embodiment of a communications architecture.

### DETAILED DESCRIPTION

Various embodiments are generally directed to systems and methods of game playing that automatically perform one or more of a plurality of actions required to continue game play on behalf of a participant when the participant is absent for an extended period or is no longer interested in being actively involved in game play. This maintains competitiveness of the game as a whole as well as the game experience for the other participants still actively involved in game play. A computer-implemented game method comprises determining if an extended absence flag has been triggered for a first game participant. If the extended absence flag has been triggered, the computer-implemented game method automatically performs one or more of a plurality of actions required to continue game play on behalf of the first game participant including responding to an event message from a second game participant in response to the one or more of a plurality of actions required to continue game play on behalf of the first game participant and updating a game profile of the first game participant based on the plurality of actions required to continue game play and the event message from a second game participant corresponding to the one or more of a plurality of actions.

Although the present disclosure describes gaming mechanics that are focused on embodiments that relate to sports, these same gaming mechanics can be used in any sort of game and gaming mechanics where a platform utilizes data from a real time gaming situation with the same rules, functions and mechanics described herein, to simulate a game based upon the same rules and mechanics with the same data and/or different data that is being supplied in a different way for a different purpose depending on the type of game. For example, the gaming mechanics may comprise any electronic game that involves interaction with a user interface to generate multimedia feedback on an electronic platform, such as a computing device, video game console, handheld computer, arcade machine, and so forth. The games may include any genre based on many factors such as game play, types of goals, art style and more, and may include without limitation graphic adventures, point-and-click adventures, text adventures, sports, first-person adventures, first-person shooters, comic adventures, anime adventures, interactive television games and so forth. It may be appreciated that any number of different games and gaming mechanics may be implemented for a given game that provides assistance to users/participants to facilitate game play. However, the embodiments are not limited in this context.

Generally and for purposes of this disclosure, game play may include various games including, but not limited to, table games, fantasy sports games, interactive television games, as well as other simulation games. For example, fantasy sports games may be associated with real-life sports, professional and/or amateur (e.g. college football), having multiple games in an individual season. The operation and function of a fantasy sports league is generally known and typically comprises at least two fantasy teams formed of fantasy players selected or drafted to comprise a fantasy team roster. Each of the fantasy players represent a real-life athlete that participates in a professional or amateur real-life sport. The real-life statistics of each player on each fantasy team are compiled after each real-life game. The statistics correlate to a particular number of fantasy points as mentioned above.

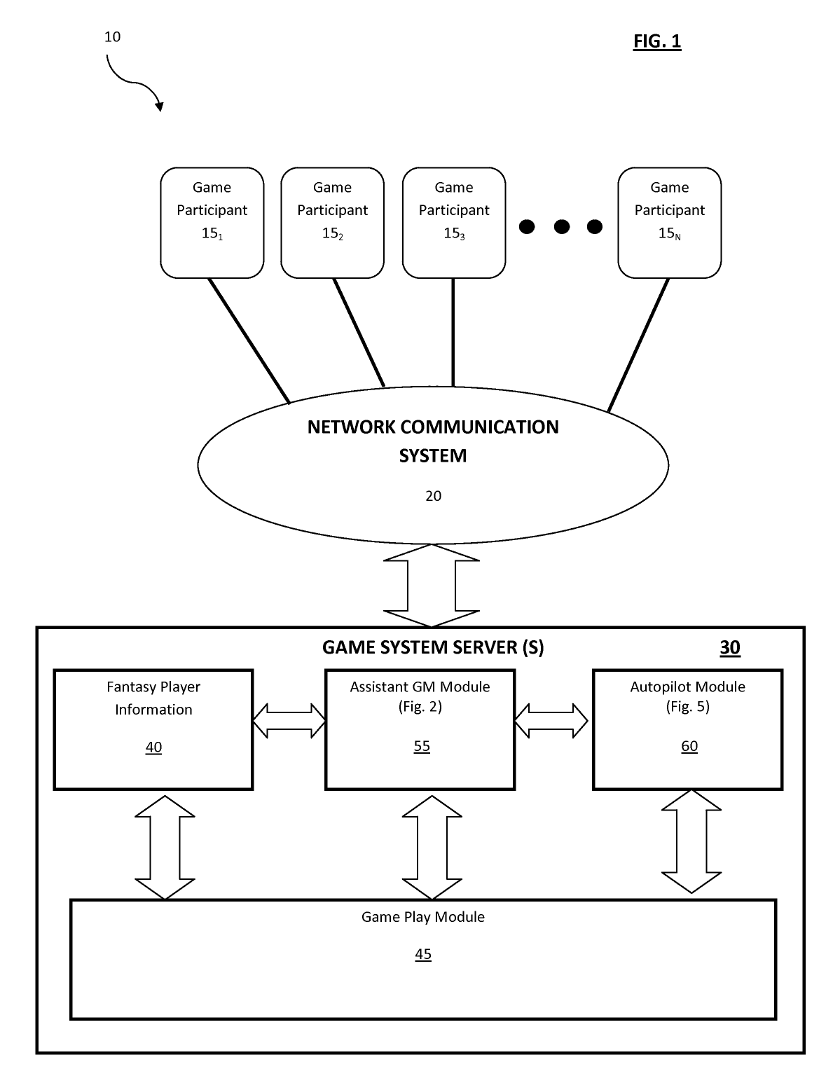

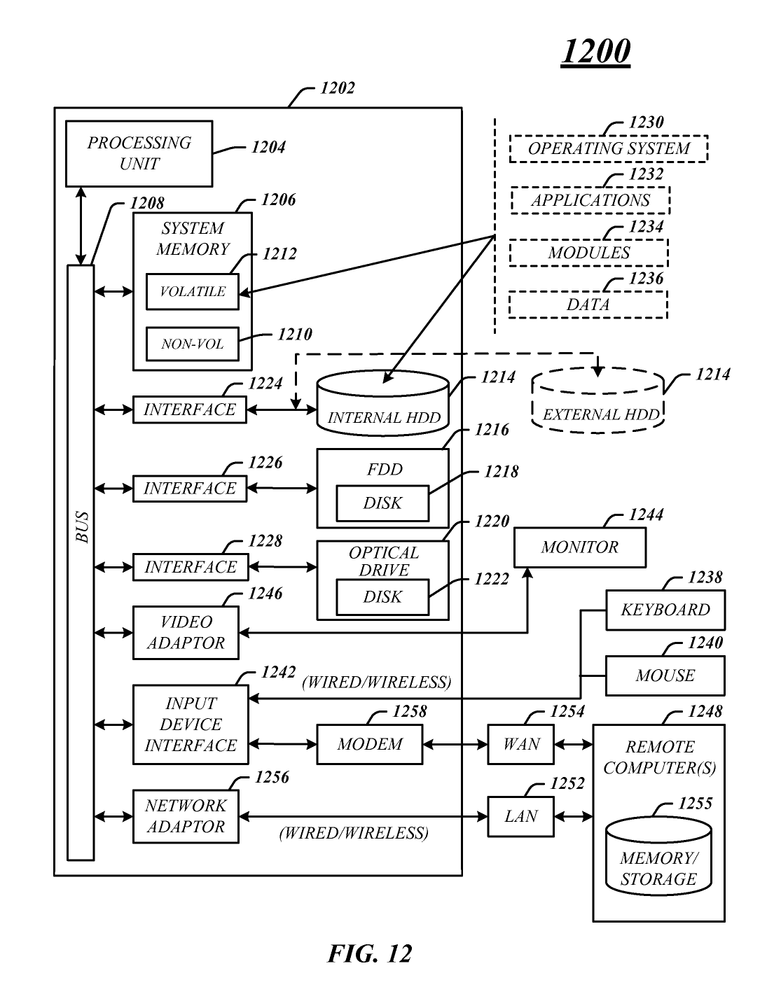

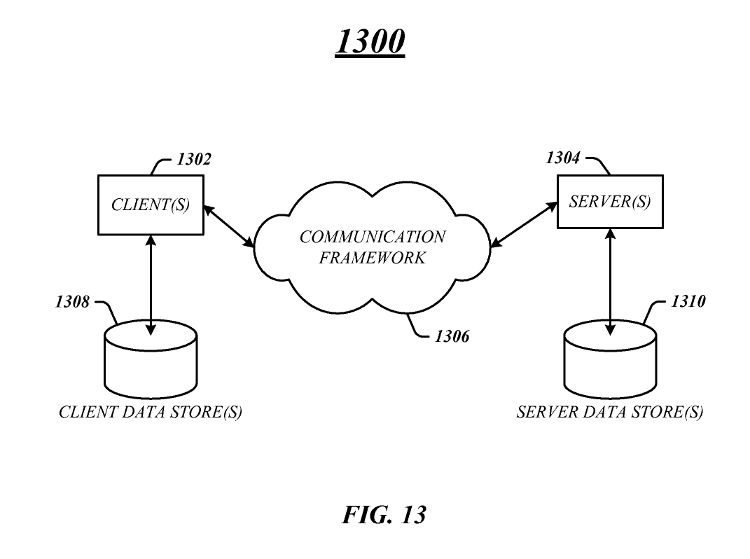

FIG. 1 illustrates a block diagram of a game system 10 comprising a plurality of game participants 15₁ . . . 15_{N}, a network communication system 20 that allows each of the plurality of game participants 15 . . . 15_{N} to communicate with game system server(s) 30. As mentioned above, the game system 10 may be configured to support any one of a plurality of game types utilizing an autopilot module 60 to simulate game play in place of an absent or uninterested participant. However, for the purposes of illustration, the system 10 will be described as a fantasy sports system and each of the game participants 15 . . . 15_{N} may access the system server(s) 30 utilizing participant devices having the exemplary computer architecture as described with reference to FIG. 12. The network communication system 20 may be broadly interpreted as a network of any type or an interconnection of a plurality of networks providing bi-directional communication between each of the participants and the fantasy sports system server(s) 30 as described with reference to FIG. 13.

As would be appreciated by those of ordinary skill in the art, game system server(s) 30 provides access to fantasy game information and facilitates fantasy game play by each of the plurality of fantasy sports participants 15₁ . . . 15_{N}. For example, fantasy sports system server(s) 30 may store fantasy player information in module 40 for one or more fantasy teams in one or more fantasy leagues including, for example, fantasy player statistics, text data, images, audio, video, etc. This information is managed by the fantasy sports system server(s) 30 and accessed by participants in order to facilitate game play using game play module 45. As used herein, “statistics” includes any identifiable, measurable, monitored or recorded action by a real-life player in the player's real-life sport. Each real-life sport includes commonly used statistics which translate into points associated with the fantasy sports league. Statistics are calculated, input, or provided by one or more databases either manually or preferably automatically and/or electronically, i.e., by computer or similar processing devices and stored in fantasy player information module 40. Electronically includes, but is not limited to computer, Internet, or other suitable electronic processing. Automatic updating can occur at set time intervals which may depend on the type of fantasy sport (e.g. football may be updated once per week), customized when a fantasy league is organized or upon request by a game participant. In addition, the statistics may be provided independently by a separate system or integrated with system 10. In further variations, the statistics are received in real-time and/or the player updates are generated automatically or upon request.

Included as part of the fantasy sports system server(s) 30 is a game play module 45, an assistant general manager (GM) module 55 and an autopilot module 60. Game play module 45 facilitates game play for the users/participants 15₁ . . . 15_{N}. In various embodiments, logic for the game play module 45 and system 10 may be programmed in accordance with various programming languages, application platforms and application frameworks, including JAVA made by Oracle Corporation, COLDFUSION made by Adobe Systems Incorporated, .NET made by Microsoft® Corporation, WebORB for .NET, Hypertext Preprocessor (PHP), Ruby, Python, Perl, Lisp, Dylan, Pike, Cluster (CLU), Smalltalk, Eiffel, Ruby on Rails (RoR), C, C++, C#, and so forth. The logic may also comprise part of a RIA, such as a front-end of a SOA for deployment on a web browser of a client computing device using various client side technologies, such as an Adobe Flash platform programmed in an object-oriented programming language such as ACTIONSCRIPT™ and ADOBE® FLEX, made by Adobe Systems Incorporated. It may be appreciated that these programming languages are provided by way of example and not limitation. Logic for game play module 45 and associated system 10 may be implemented using any suitable programming language.

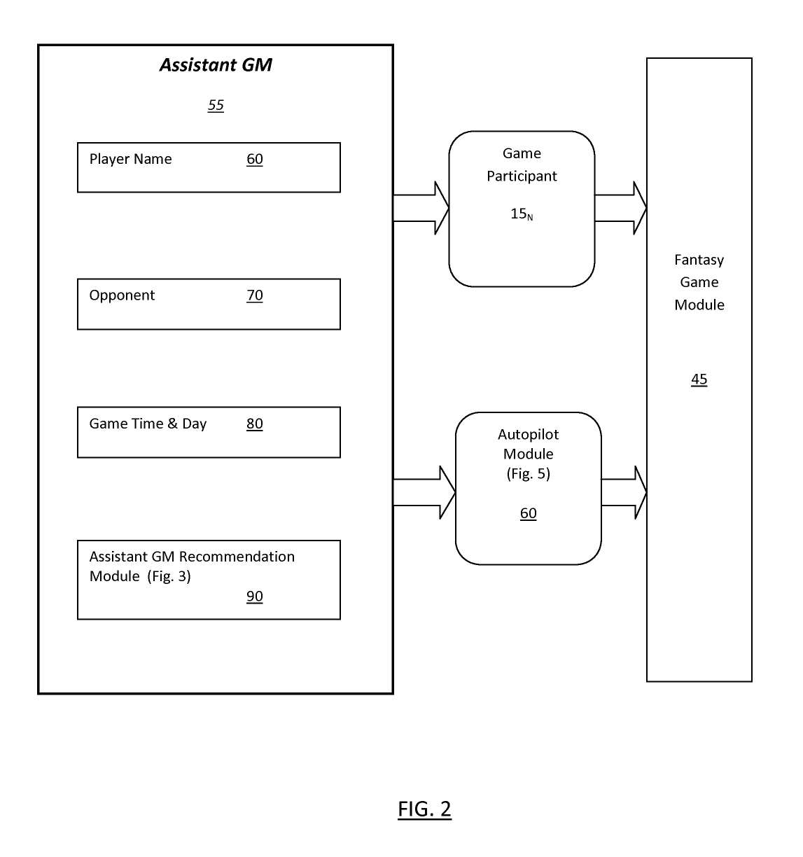

Assistant general manager (GM) module 55 accesses fantasy player information from fantasy player information module 40 based on requests from the game participants 15₁ . . . 15_{N} in order to allow each participant to generate and modify a participant's game profile comprised of a player roster as well as providing the ability to manage a participant's roster for a given competition. In particular, the assistant GM module 55 provides a participant access to information about one or more players. For example, once a participant accesses the assistant GM module 60, information such as the player's name, upcoming opponent, game time and day as well as access to a recommendation module 90 (see FIG. 2). Changes in fantasy team line-ups may occur during a fantasy season, such as by replacement of players for non-performance, injury, or other reasons, including trade of roster players among game participants. Additionally, players may be reserved, benched, activated or started, as specific league rules permit. Assistant GM module 55 also allows a participant the ability to modify the extent of recommendations provided to the participant to facilitate customized game play. This allows for greater customization by the participant so the participant can orient this system to provide varying levels of player recommendations from automatically executing roster changes for the participant to providing recommendation information to the participant.

Autopilot module 60 is stored within game system server(s) 30 and communicates with the assistant GM module 55 and game play module 45 to simulate game play by a game participant 15_{N} that: (a) has activated an extended absence flag; and/or (b) has lost interest in the game play and has decided to discontinue participation. The absence of one or more participants 15₁ . . . 15_{N} from the game play function may compromise the experience for the remaining participants since part of the game experience is that each participant maintains a competitive team. If one or more of the participants 15₁ . . . 15_{N} is not actively playing the game, the disinterested participant's team degrades the game experience for the other participants. In addition, players on the disinterested participant's roster are locked up and would otherwise be accessible by the other participants still actively involved in game play.

The assistant GM module 55, fantasy player information 40 and autopilot module 60 as well as other components and data are communicatively coupled via various types of communications media. Game system server 30 manages operations and communication between assistant GM module 55, fantasy player information 40 and autopilot module 60 within game module 45. The coordination may involve the uni-directional or bi-directional exchange of information. For instance, the fantasy game module 45 may control the fantasy sports server(s) 30 to manage communication in the form of signals communicated over communications media between each of the components and/or functions therein as well as with the game participants 15₁ . . . 15_{N} via network communication system 20.

A new and unique operational aspect of game system 10 in accordance with the present disclosure as provided by the game system server(s) 30 is directed to utilization of the autopilot module 60 which automatically performs actions required to continue game play on behalf of a game participant as if the game participant was still actively involved in game play. This is accomplished by autopilot module 60 receiving information from assistant GM module 55 and automatically executing actions that would otherwise be performed by an active game participant 15₁ . . . 15_{N}.

FIG. 2 illustrates assistant general manager (GM) module 55 which provides input to autopilot module 60 to identify game players to be recommended to a participant in order to update, change or otherwise modify a participant's roster. In particular, within the fantasy sports system server(s) 30, the assistant GM module 55 identifies the player name 65, upcoming opponent information 70, game time and day 80 and allows access to the assistant GM recommendation module 90 to provide recommendations to participants (e.g. participant 15_{N}) in making lineup decisions easily and quickly.

When a participant is actively engaged in game play, these recommendations are considered and may or may not be acted upon by a participant. However, when a participant is no longer actively engaged in game play either by activating an extended absence flag and/or by discontinuing active game play for a predetermined period, the recommendations provided by assistant GM module 55 to the inactive participant are not acted upon. Thus, the quality of the players on the inactive participant's roster will be compromised thereby decreasing competitiveness of game play among the remaining participants. Autopilot module 60 is activated when the extended absence flag is triggered or when a participant has been inactive for an extended period. The recommendations determined by assistant GM module 55 are communicated to autopilot module 60. Autopilot module 60 receives these recommendations from assistant GM module 55 and interfaces with fantasy game module 45 to automatically manage game play as well as the roster of players on behalf of the inactive participant as described in more detail below.

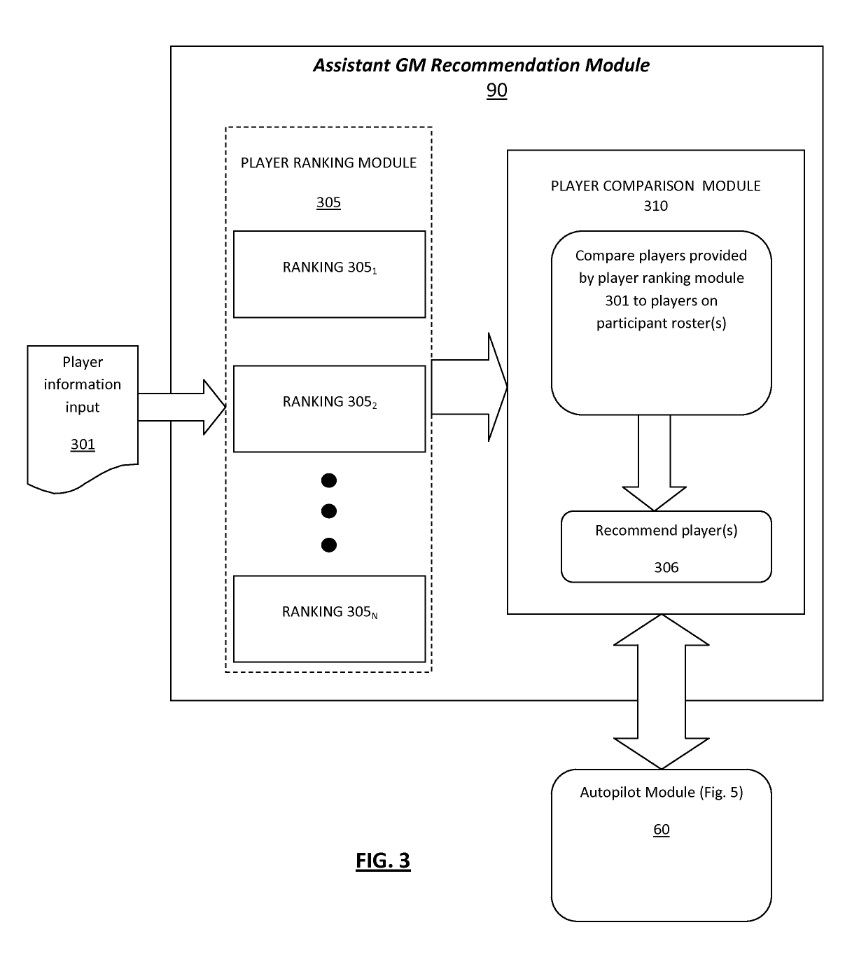

FIG. 3 illustrates the assistant GM recommendation module which includes player ranking module 305, and player comparison module 310. Generally, assistant GM module compares player ranking information 301 with the players in a participant's roster to provide the participant with fantasy player recommendations. In particular, information about the performance of particular players 301 is input to player ranking module 305. The particular players and the type of information contained in player information input 301 is the subject of U.S. patent application Ser, No. 12/965,532, entitled Fantasy Sport Talent Scout System and Method Therefore, filed Dec. 10, 2010, assigned to the assignee of the present application. The fantasy players at a particular position are ranked by player ranking module 305 based on the received information 301. Fantasy player ranking module 305 may include a plurality of ranking sub-modules 305₁ . . . 305_{N} used to rank players based on various parameters. For example, sub-module 305₁ may be used to rank all players at a particular position. Sub-module 305₂ may be used to rank only the top N number of players at a position different from the position ranked by sub-module 305₁ and so on with respect to sub-module 305_{N}. In this manner, the player ranking module 305 is used to rank different players at different positions based on game and/or participant preferences.

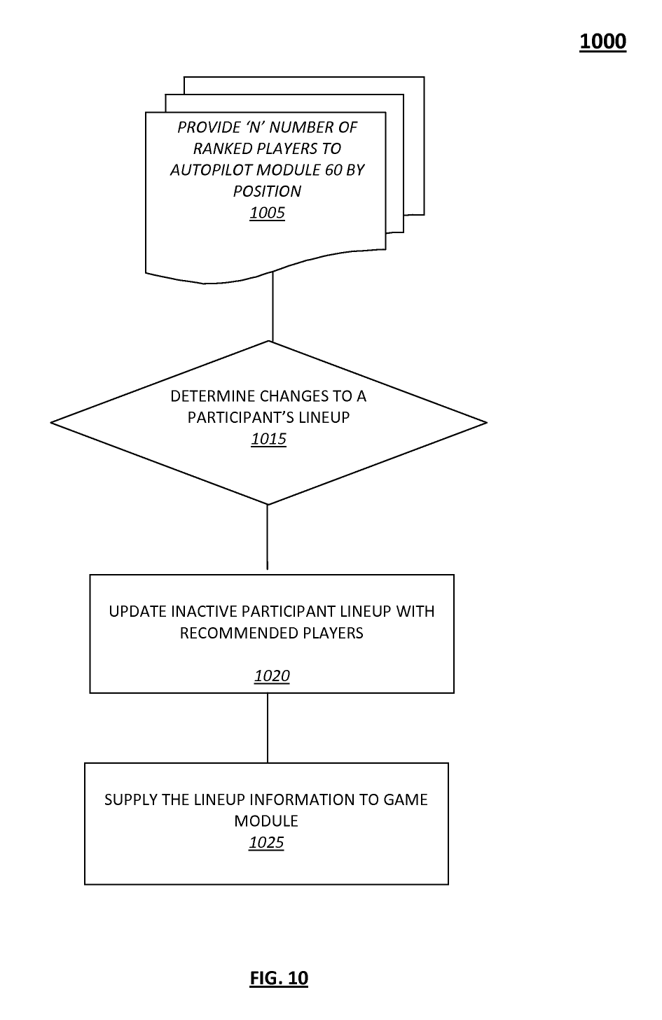

The ranking information is provided to player comparison module 310 which compares the player rankings with a player roster associated with a particular game participant 15₁ . . . 15_{N}. These ranked players are compared to the corresponding player at the same position on a participant's roster by player comparison module 310. If a player is compared to a participant's roster player at the same position and is ranked higher than the participant's player at module 310, then the identity of the ranked player is recommended at 306. The number ‘N’ of ranked players compared to each position of a participant's roster is customizable and may be, for example, three or four players. Thus, a participant has a choice of N players provided at 306 to choose from to replace the corresponding player on the participant's roster. This replacement may be by starting a bench player or trading for another player as outlined in FIG. 10. In this manner, the assistant GM recommendation module 310 determines if a player is of a caliber and quality to deserve a roster spot on a participant's team. Assistant GM recommendation module 90 would typically provide the recommended player(s) information at 306 to a participant who would then initiate roster replacement by trade, free agent acquisition, etc. to upgrade the participant's roster for the next scheduled competition. However, when a participant is absent for an extended period and/or has triggered an extended absence flag, the player recommendation information is sent to autopilot module 60.

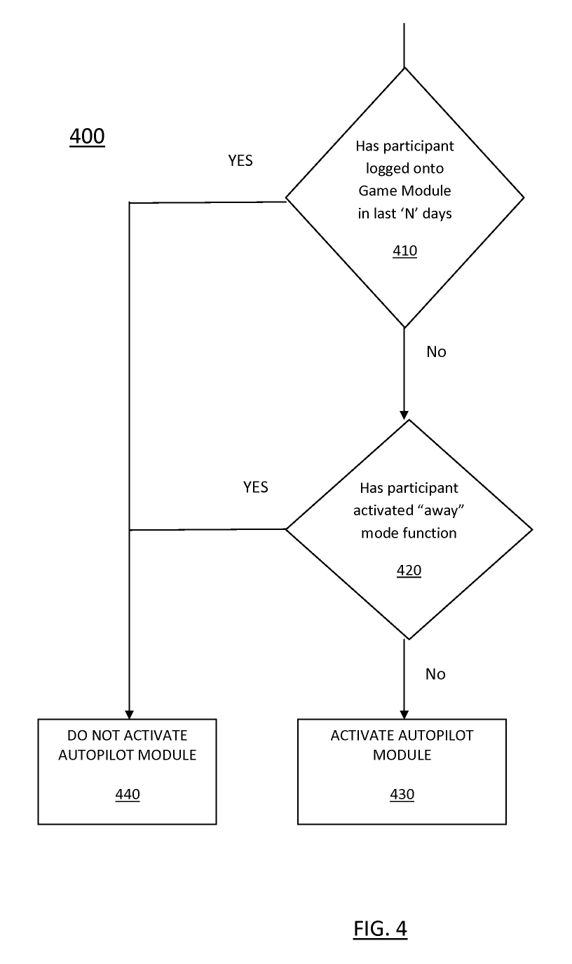

FIG. 4 illustrates a logic flow to determine whether or not player recommendations are sent to autopilot module 60. In particular, game play module 45 communicates with autopilot module 60 to determine, at block 410, whether a participant has logged onto game system 10 in the last ‘N’ days. If a participant has logged onto the game system 10 within the last N days, the process proceeds to block 440 and the autopilot 60 module is not activated. Again, the autopilot module 60 is activated only when system 10 determines that a participant is not actively engaged in game play. The determination of what “actively” means can be customized for the particular game. If the system determines that a participant has not logged into the game system 10 within the last N days, the process proceeds to block 420 in which a determination is made whether or not the participant has activated an extended absence flag. A participant may trigger such an extended absence flag when they expect to be unable to login to the system for a period of time because of, for example, business travel, vacation, etc. If the participant has triggered the extended absence flag, the process proceeds to block 440 and the autopilot module is not activated. If the participant has not triggered the extended absence flag and the participant has not logged onto the system in the last N days, the process proceeds to block 430 and the autopilot module is activated to automatically manage game play as well as the roster of players on behalf of the inactive participant.

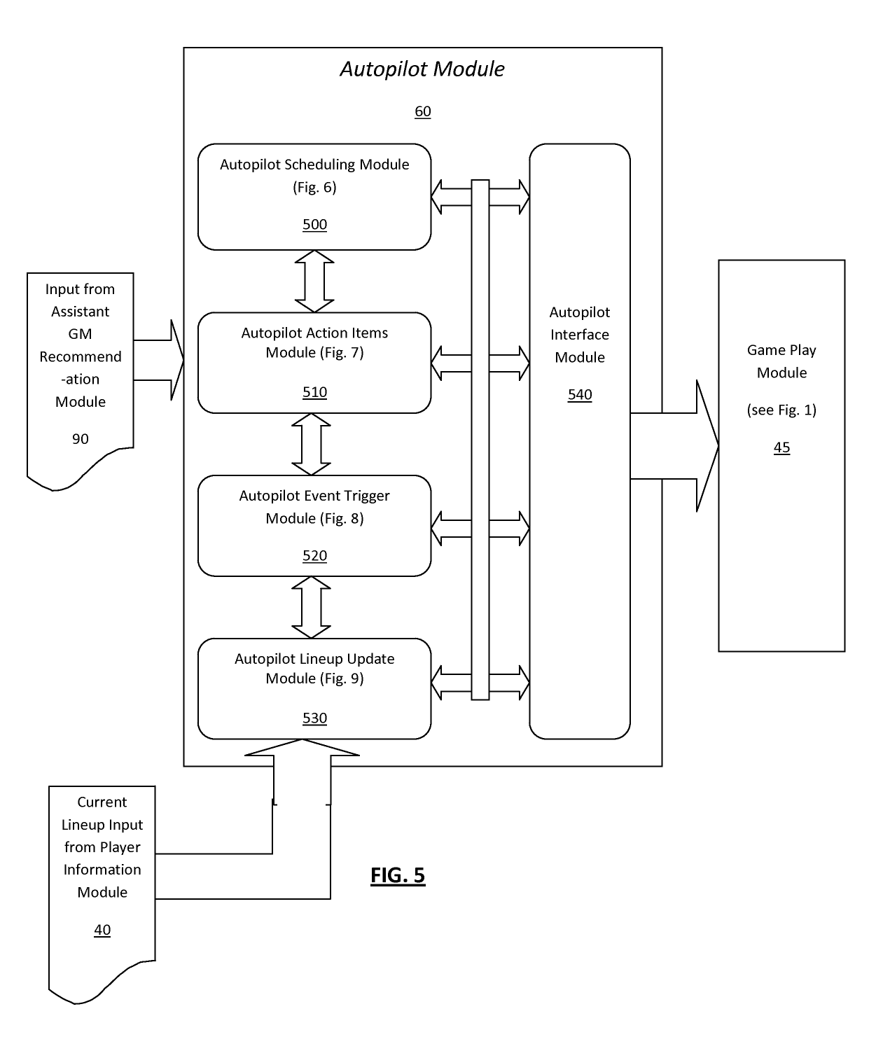

FIG. 5 is a block diagram of autopilot module 60 including autopilot scheduling module 500, autopilot action items module 510, autopilot event trigger module 520, autopilot lineup module 530 and autopilot interface module 540. Autopilot module 60 receives player recommendations from assistant GM recommendation module 90, determines changes to a participant's lineup, updates the lineup with recommended players if necessary, and supplies the lineup information to game module 45. Essentially, autopilot module 60 simulates game play by a game participant 15_{N} when the participant is no longer active in game play. In particular, autopilot scheduling module 500 manages particular deadlines associated with game play and provides this information to autopilot action items module 520. For example, autopilot scheduling module manages line-up deadlines, trade deadlines, etc. as well as tracking which real-life players are active for a given competition and which real-life players are inactive because of injury, bye week, etc. Autopilot action items module 510 receives the deadline information from scheduling module 500 and recommendation information from assistant GM recommendation module 90 to determine if a trade or line-up change is appropriate before a given deadline. For example and as explained previously with respect to FIG. 3, assistant GM recommendation module 90 provides autopilot module 60 and in particular autopilot action items module 510 provides the participant 15_{N} with fantasy player recommendations based on ranking of players as compared with the participant's lineup.

Autopilot action items module 510 receives these recommendations and updates the participant's lineup with a) bench or roster player(s) from the participant's roster if the bench player(s) are ranked by assistant GM module 90 higher than the participant's lineup players; (b) generates trade offers if the ranked player from assistant GM module 90 is a member of another team; or (c) generates a free agent acquisition if the ranked player from the assistant GM module 90 is a free agent (i.e. not a member of any team in the league). These actions may be initiated and carried out with other participants consistent with league rules including, but not limited to, email requests, league posting, system communication, etc. In particular, action items module 510 generates a trade offer from the inactive participant 15_{N} to one or more of the active participants 15₁ . . . 15_{N-1}. Event trigger module 520 processes the response from the active participant in connection with the trade offer.

Autopilot event trigger module 520 processes messages received from other participants in response to the trade requests generated by action items module 510. In particular, an active participant in response to a trade offer from autopilot action items module 510 may or may not want to participate in the proposed trade. Based on the preference of the active participant, autopilot event trigger module 520 receives a response to the trade offer and either executes the trade or, if the active participant rejected the trade offer, moves to the next ranked player at that position from the assistant GM recommendation module 90. Autopilot event trigger module 520 notifies action items module 510 that the trade was rejected and action items module determines if the next ranked player at that position is on the inactive participant's roster. In this case, event trigger module 520 will activate that player, or if the next ranked player is on another participant's roster, generate another trade request, or if the next ranked player is a free agent, add that free agent to the inactive participant's lineup. In this manner, autopilot event trigger module processes the responses from active participants generated by action items module 510 and provides instructions to action items module 510 based on such responses.

Autopilot lineup update module 530 receives instructions from event trigger module 520, scheduling module 500 and action items module 510 to provide a modified or updated lineup supplied to interface module 540. In particular, lineup update module 530 receives the current inactive participant's lineup from player information module 40 as well as any confirmed trades, free agent acquisitions and/or bench player substitutions from event trigger module 520 and provides an updated lineup prior to any deadlines as per scheduling module 500 to autopilot interface module 540. It is important to note that lineup update module 530 is provided as an example for a particular sports related game system 10. It should be understood that that this module may be modified based on the type of game being played.

Autopilot interface module 540 communicates with scheduling module 500, action items module 510, event trigger module 520, and lineup update module 530 to supply a competitive lineup to game play module 45. In particular, autopilot interface module 540, in combination with scheduling module 500, determines when a lineup for the inactive participant must be supplied to game play module 45. For example, if scheduling module determines that a lineup must be supplied by Thursday at 8 pm Eastern Time for a football fantasy sports game; autopilot interface module 540 receives this deadline information from scheduling module 500 and ensures that autopilot lineup update module 520 supplies this information by the prescribed deadline. In the event that autopilot action items module 510 does not receive a response from an active participant regarding a trade offer by a particular date and/or time as predetermined by scheduling module 500, autopilot lineup 530 may sign a free agent, or activate a bench player from the inactive participant's roster, for example, in order to provide a lineup to game play module 45 by the deadline.

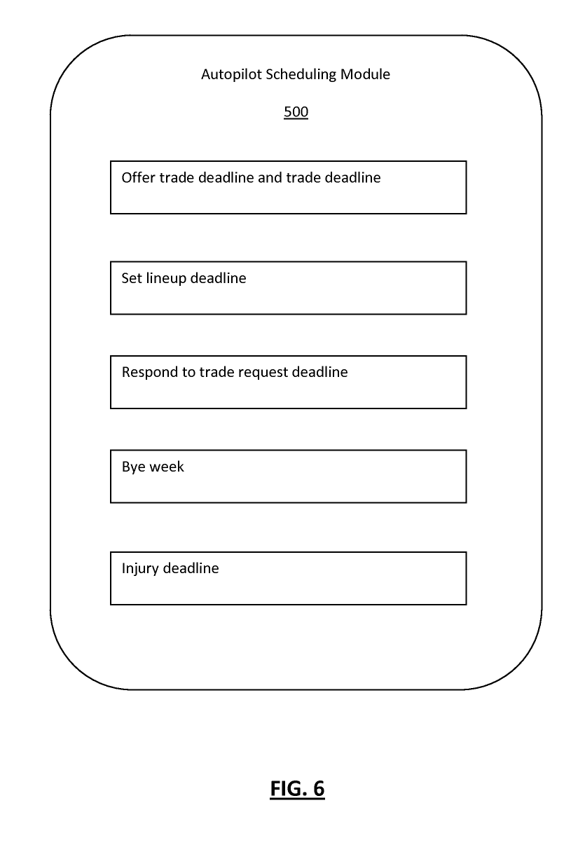

FIG. 6 is a block diagram illustrating exemplary information stored in autopilot scheduling module 500. In particular, scheduling module 500 includes scheduling and deadline information stored in memory customized for a particular league. For example, game module 10 may be programmed to run a sports fantasy game such as football. In such an exemplary game play, scheduling module 500 may include offer and trade deadline information, set lineup deadline information, respond to trade request deadline, bye week information and injury information deadline. In particular, specific league rules may be programmed to allow for 24 hours to respond to trade offers between participants, or league rules may provide that lineups may be modified up to the start of the first actual game representing the fantasy competition to provide for last minute replacements. This type of information is stored in scheduling module 500 and accessed by the other modules of autopilot 60.

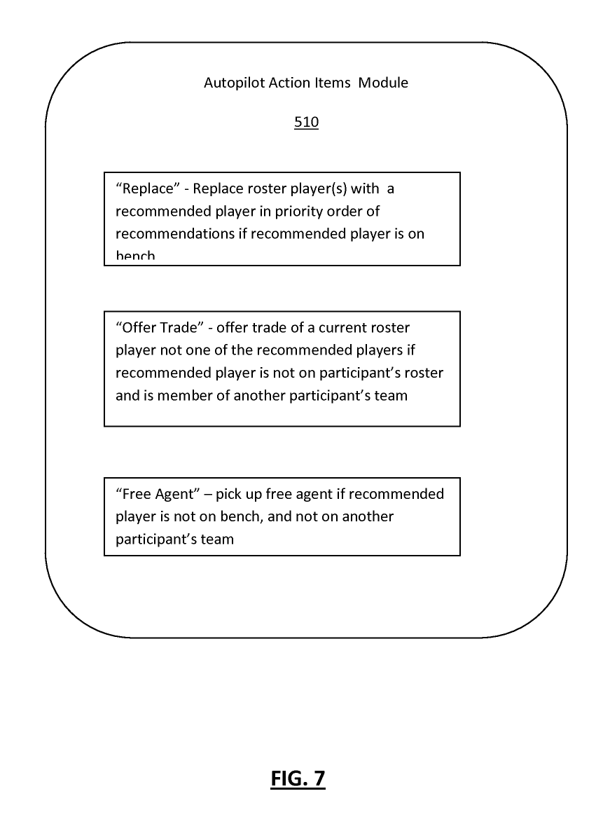

FIG. 7 is a block diagram illustrating exemplary functions of autopilot action items module 510. A function of this module, as previously mentioned, is to replace a player on the inactive participant's lineup with a player on the inactive participant's bench if one or more of the ranked players provided by assistant GM module 55 are on the inactive participant's roster. Another function of autopilot action items module 510 is to offer a trade of a current roster player on the inactive participant's roster if the recommended or ranked player(s) from assistant GM module 55 is not on the inactive participant's roster. Another function of autopilot action items module 510 is to replace an existing inactive participant player with a free agent player that is ranked higher than the inactive participant's player.

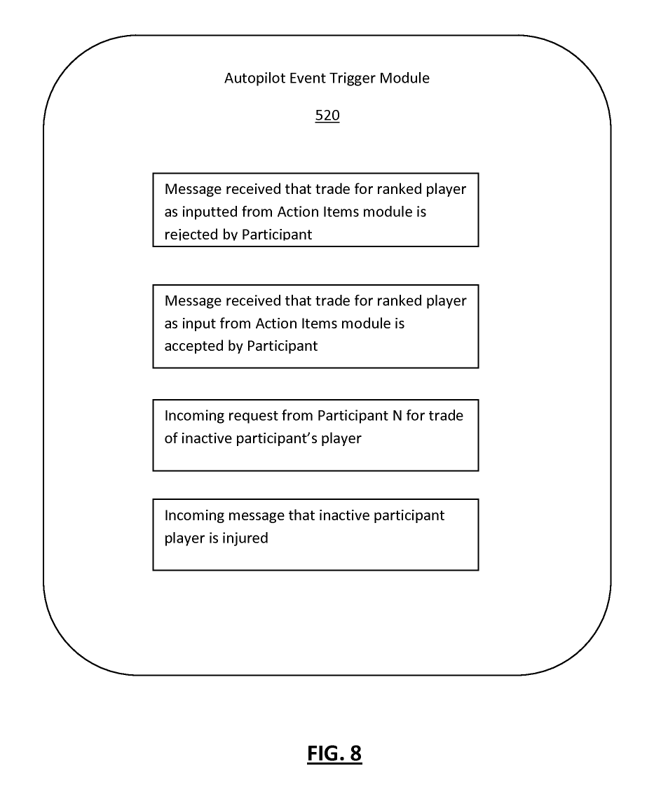

FIG. 8 is a block diagram illustrating exemplary functions of autopilot event trigger module 520. Essentially, event trigger module receives messages and/or responses from active participants on behalf of the inactive participant and determines an appropriate response. In particular, event trigger module may receive a message that a trade offer submitted by the action items module 510 was rejected by the active participant or that the proposed trade offer was accepted by the active participant. Depending on the response received for such a trade offer, event trigger module 520 determines an appropriate response. For example, in the event that a trade offer for a player at a particular position submitted by the action items module 510 was rejected by the active participant, event trigger module 520 communicates with action items module 510 that the trade was rejected. This allows action items module 510 to identify the next player of the N players recommended by assistant GM module 55 at the particular position and determine whether or not this player is on the inactive participant's roster as a bench player, on the roster of another participant thereby requiring another trade offer, or currently a free agent necessitating acquisition. In this manner, event trigger module 520 receives and processes communication from active participants in response actions performed by action items module 510.

Similarly, autopilot event trigger module 520 also processes communication received from active participants either in response to actions initiated by action items module 510 or by actions initiated from an active participant directed to the inactive participant. For example, event trigger module 520 may process incoming trade offers from participant N for one or more players on the inactive participant's roster. Event trigger module 520 also processes incoming messages that a player on the inactive participant's roster is injured or otherwise not expected to compete in the upcoming competition. Accordingly, event trigger module notifies autopilot update module 530 and scheduling module to remove the injured player from the inactive participant's lineup.

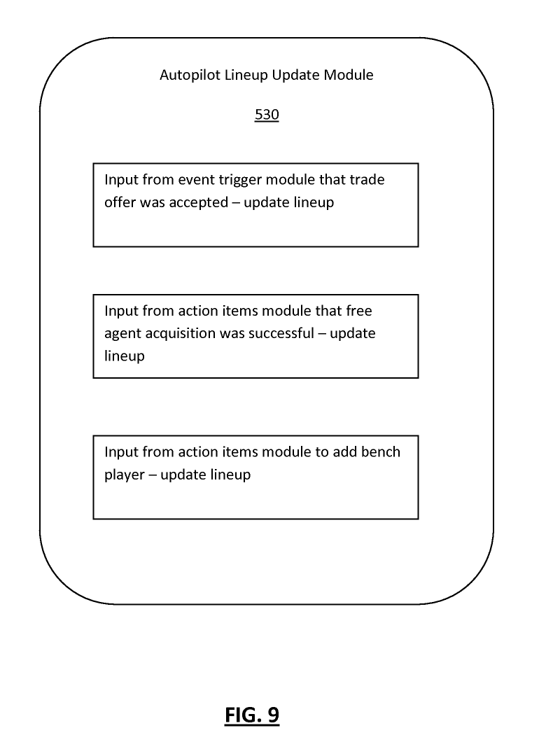

FIG. 9 is a block diagram illustrating exemplary functions of autopilot lineup module 530 which essentially updates an inactive participant's roster based on trades, free agent acquisitions and/or activation of bench players. In particular, lineup update module 530 receives input from event trigger module 520 that a trade offer was accepted by an active participant. The identity and position of the player is supplied by event trigger module 530 or from action items module 520 and the lineup module 530 updates the lineup of the inactive participant with the player obtained via trade. Similarly, lineup update module 530 receives input from event trigger module 520 that a free agent acquisition was successful. The identity and position of the player is supplied by event trigger module 530 or from action items module 520 and the lineup module 530 updates the lineup of the inactive participant with the free agent player. Similarly, lineup update module 530 receives input from event trigger module 520 that a bench player on the inactive participant's roster was activated. The identity and position of the player is supplied by event trigger module 530 or from action items module 520 and the lineup module 530 updates the lineup of the inactive participant with the activated bench player.

Operations for the above-described game system embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

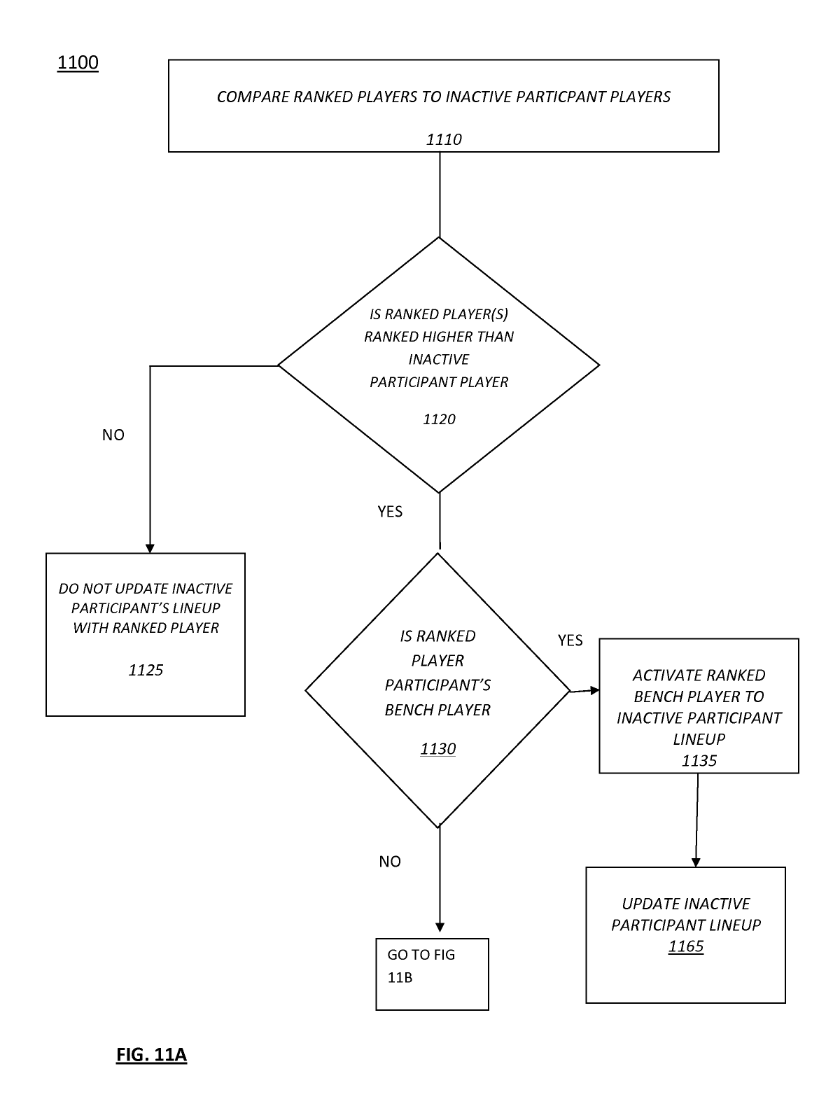

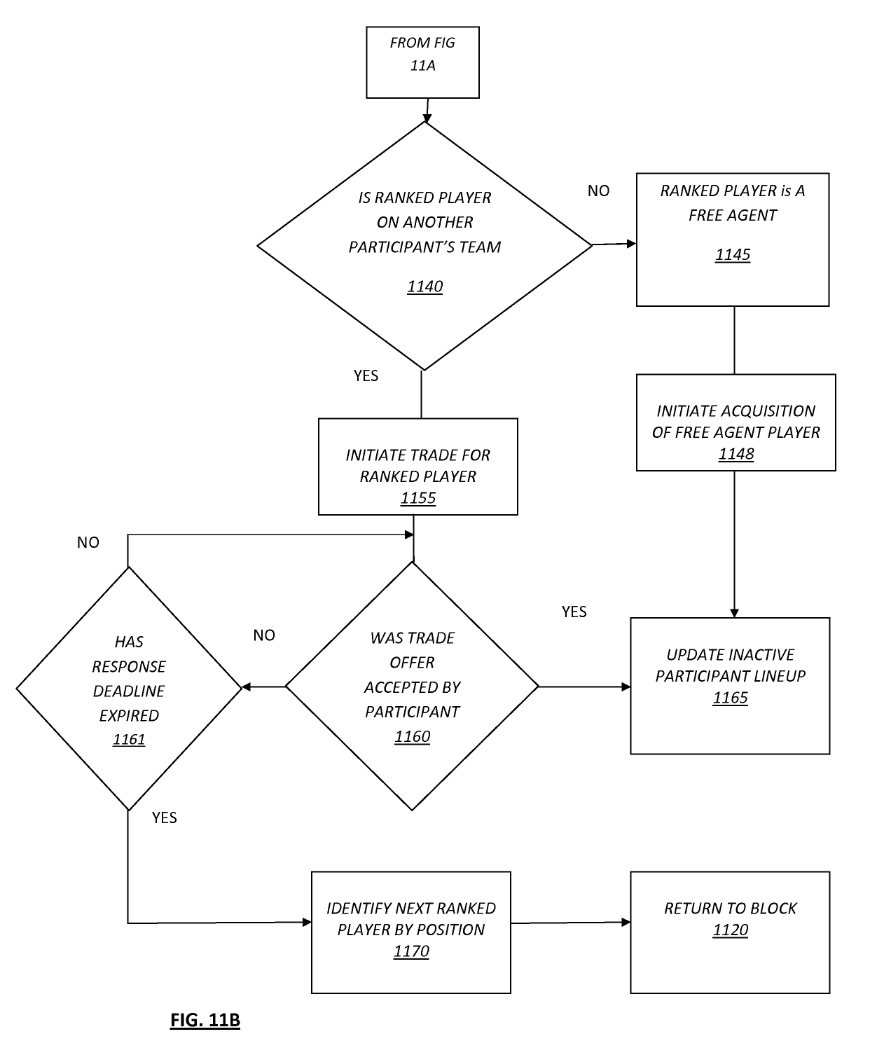

FIG. 10 illustrates an embodiment of a logic flow 1000. The logic flow 1000 may be representative of some or all of the operations executed by one or more embodiments described herein, such as the system 10, for example. In the illustrated logic flow 1000 shown in FIG. 10, the autopilot module 60 receives player recommendations from assistant GM recommendation module 90 at block 1005. Autopilot module 60 determines changes to a participant's lineup at block 1015 as described in more detail with reference to FIG. 11. At block 1020, autopilot module 60 updates the lineup of the inactive participant with ranked or recommended players depending on whether or not the ranked players are ranked higher than existing players on the inactive participant's lineup. The logic flow 1000 continues to block 1025 which supplies the lineup for the inactive participant to game module 45 to provide competitive play for all participants 15₁ . . . 15_{N}.

FIG. 11 illustrates a logic flow 1100 which is an exploded view of block 1015 shown in FIG. 10. The ranking of inactive participant lineup players at each position is compared to the ranked players at step 1110. After this comparison, a determination is made at step 1120 if the ranked players are ranked higher than players on the inactive participant's lineup at the corresponding position. If the ranked players are not ranked higher than a player on the inactive participant's lineup, then the process proceeds to step 1125 and no player is updated to the inactive participant's lineup. If the ranked players are ranked higher than a player on the inactive participant's lineup, then the process proceeds to step 1130 where a determination is made whether or not the ranked player at the particular position is a bench player on the inactive participant's roster. If the ranked player is on the inactive participant's roster, then the process proceeds to step 1165 where the inactive participant's lineup is updated.

If the ranked player is not a bench player of the inactive participant or is not on the roster of the inactive participant, then the process proceeds to step 1140 of FIG. 11B where a determination is made if the ranked player, at that position, is on an active participant's team. If this condition is not satisfied, then the process proceeds to step 1145 and the ranked player must be a free agent. A free agent acquisition is initiated for the ranked player by the inactive participant and the process proceeds to step 1165 where the inactive participant lineup is updated. If, at step 1140, it is determined that the ranked player is on another participant's team, a trade offer is initiated for the ranked player at step 1155. At step 1160, a determination is made if the trade offer was accepted by the active participant. If the trade offer was accepted the process proceeds to step 1165 and the inactive participant lineup is updated with the ranked player at that position. If the trade offer was not accepted by the active participant, the process proceeds to step 1161 to determine if the deadline for a response to the trade offer has expired. If the response deadline has not expired, the process returns to step 1160. If the response deadline has expired, the process proceeds to step 1170 where the next ranked player at that particular position is identified and the process returns to step 1120. It should be noted that each of these steps in the process may be customized to provide player recommendations for lineup changes, drafts, trades, etc., based on league or game play rule preferences. In addition, the number and details of each ranked player provided by assistant GM module 55 may be dependent on game play rules. Moreover, a limitation on the number of trade requests for the same player on an active participant's roster may be limited by league rules.

Although the above disclosure has described the computer implemented method in a context relating to sports gaming, it is important to note that these same described mechanics can be used in any sort of game and/or game simulation where a platform utilizes data from a real time gaming situation with the same rules, functions and mechanics described herein, to simulate a new game based upon the same rules and mechanics with the same data and/or different data that is being supplied in a different way for a different purpose depending on the type of game and/or simulation.

FIG. 12 illustrates an embodiment of an exemplary computing architecture 1200 suitable for implementing various embodiments of the system and methods as previously described. In particular, the computing architecture 1200 may be used by a participant 15₁ . . . 15_{N} and/or the server(s) 30 and/or a portion thereof. The computing architecture 1200 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 1200.

As shown in FIG. 12, the computing architecture 1200 comprises a processing unit 1204, a system memory 1206 and a system bus 1208. The processing unit 1204 can be any of various commercially available processors. Dual microprocessors and other multi-processor architectures may also be employed as the processing unit 1204. The system bus 1208 provides an interface for system components including, but not limited to, the system memory 1206 to the processing unit 1204. The system bus 1208 can be any of several types of bus structure that may further interconnect to a memory bus (with or without a memory controller), a peripheral bus, and a local bus using any of a variety of commercially available bus architectures.

The system memory 1206 may include various types of memory units to store information in system 10 and may be, for example, read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 12, the system memory 1206 can include non-volatile memory 1210 and/or volatile memory 1212. A basic input/output system (BIOS) can be stored in the non-volatile memory 1210.

The computer 1202 may include various types of computer-readable storage media, including an internal hard disk drive (HDD) 1214, a magnetic floppy disk drive (FDD) 1216 to read from or write to a removable magnetic disk 1218, and an optical disk drive 1220 to read from or write to a removable optical disk 922 (e.g., a CD-ROM or DVD). The HDD 1214, FDD 1216 and optical disk drive 1220 can be connected to the system bus 1208 by a HDD interface 1224, an FDD interface 1226 and an optical drive interface 1228, respectively. The HDD interface 1224 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1210, 1212, including an operating system 1230, one or more application programs 1232, other program modules 1234, and program data 1236 applicable to system 10. The one or more application programs 1232, other program modules 1234, and program data 1236 can include, for example, the game system 10, the systems used by game participants 15₁ . . . 15_{N}, and/or the game system server(s) 30.

A game participant 15₁ . . . 15_{N} can enter commands and information into the computer 1202 through one or more wire/wireless input devices, for example, a keyboard 1238 and a pointing device, such as a mouse 1240. Other input devices may include a microphone, an infra-red (IR) remote control, a joystick, a game pad, a stylus pen, touch screen, or the like. These and other input devices are often connected to the processing unit 1204 through an input device interface 1242 that is coupled to the system bus 1208, but can be connected by other interfaces such as a parallel port, IEEE 1394 serial port, a game port, a USB port, an IR interface, and so forth.

A monitor 1244 or other type of display device is also connected to the system bus 1208 via an interface, such as a video adaptor 1246 and can be used to display player recommendation information R₁ . . . R_{N} to the one or more game participants 15₁ . . . 15_{N}. In addition to the monitor 1244, a computer typically includes other peripheral output devices, such as speakers, printers, and so forth.

The computer 1202 may operate in a networked environment using logical connections via wire and/or wireless communications to one or more remote computers, such as a remote computer 1248. The remote computer 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wire/wireless connectivity to a local area network (LAN) 1252 and/or larger networks, for example, a wide area network (WAN) 1254. Such LAN and WAN networking environments are commonplace in offices and companies, and facilitate enterprise-wide computer networks, such as intranets, all of which may connect to a global communications network, for example, the Internet.

When used in a LAN networking environment, the computer 1202 is connected to the LAN 1252 through a wire and/or wireless communication network interface or adaptor 1256. The adaptor 1256 can facilitate wire and/or wireless communications to the LAN 1252, which may also include a wireless access point disposed thereon for communicating with the wireless functionality of the adaptor 1256.

When used in a WAN networking environment, the computer 502 can include a modem 1258, or is connected to a communications server on the WAN 1254, or has other means for establishing communications over the WAN 1254, such as by way of the Internet. The modem 1258, which can be internal or external and a wire and/or wireless device, connects to the system bus 1208 via the input device interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

FIG. 13 illustrates a block diagram of exemplary communications architecture 1300 suitable for implementing various embodiments of game system 10 and associated methods as previously described. The communications architecture 1300 includes various common communications elements, such as a transmitter, receiver, transceiver, radio, network interface, baseband processor, antenna, amplifiers, filters, and so forth. The embodiments, however, are not limited to implementation by the communications architecture 1300.

As shown in FIG. 13, the communications architecture 1300 comprises one or more clients 1302 and servers 1304. The clients 1302 may implement the systems used by the game participants 15₁ . . . 15_{N}. The servers 1304 may implement the game system server 30. The clients 1302 and the servers 1304 are operatively connected to one or more respective client data stores 1308 and server data stores 1310 that can be employed to store information local to the respective clients 1302 and servers 1304, such as cookies and/or associated contextual information.

The clients 1302 and the servers 1304 may communicate information between each other using a communication framework 1306. The communications framework 1306 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 1302 and the servers 1304 may include various types of standard communication elements designed to be interoperable with the communications framework 1306, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 1302 and a server 1304 can be in the form of a data packet adapted to be transmitted between two or more computer processes. The data packet may include a cookie and/or associated contextual information, for example.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments of the game system 10 and associated methods may comprise an article of manufacture. An article of manufacture may comprise a storage medium to store logic. Examples of a storage medium may include one or more types of non-transitory computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may have been described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may have been described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method comprising:
determining if an extended absence flag has been triggered for a first participant;
if the extended absence flag has been triggered, automatically performing one or more of a plurality of actions required to continue game play on behalf of said first participant;
responding to an event message from a second participant in response to the one or more of a plurality of actions required to continue game play on behalf of said first participant; and
updating a profile of the first participant based on the plurality of actions required to continue game play and the event message from a second participant corresponding to the one or more of a plurality of actions.

2. The computer-implemented method of claim 1 wherein the method is a fantasy game and the profile of the first participant is a roster of game players by position.

3. The computer-implemented method of claim 2 wherein the one or more of a plurality of actions includes automatically ranking a plurality of players by position and comparing each of the ranked players to a corresponding player on the roster of the first participant by position.

4. The computer-implemented method of claim 3 wherein if the ranked player has a higher ranking than the corresponding player on the roster of the first participant, then the method further comprising:
determining if the ranked player is on the roster of the first participant; and
if the ranked player is on the roster of the first participant then automatically replacing the player on the roster of the first participant with the ranked player at the corresponding position.

5. The computer-implemented method of claim 3 wherein the ranked player is one of at least three ranked players by position, the method further comprising:
determining if any of the three ranked players has a higher ranking than the corresponding player on the roster of the first participant;
determining if the ranked player is on the roster of the first participant;
if the ranked player is not on the roster of the first participant then automatically proposing a trade to a third of the plurality of participants on which the first of the three ranked players is identified as being part of their roster; and
if the third of the plurality of participants accepts the trade, then updating the roster of the first participant with the first of the three ranked players.

6. The computer-implemented method of claim 5 further comprising:
if the third of a plurality of participants refuses to trade the first of the three ranked players, then automatically proposing a trade to a fourth of a plurality of participants on which the second of the three ranked players is identified as being part of their roster; and
if the fourth of the plurality of participants accepts the trade, then updating the roster of the first participant with the second of the three ranked players.

7. The computer-implemented method of claim 6 further comprising:
if the fourth of a plurality of participants refuses to trade the second of the three ranked players, then automatically proposing a trade to a fifth of a plurality of participants on which the third of the three ranked players is identified as being part of their roster; and
if the fifth of the plurality of participants accepts the trade, then updating the roster of the first participant with the third of the three ranked players.

8. The computer-implemented method of claim 1 wherein the step of determining if an extended absence flag has been triggered for a first participant is based on a length of time the first participant does not log on to the computer-implemented method.

9. An article of manufacture comprising a storage medium containing instructions that when executed enable a system to:
automatically determine if a game participant is not actively engaged in game play;
automatically perform one or more of a plurality of actions required to continue game play on behalf of said first game participant;
automatically respond to an event from a second game participant in response to the one or more of a plurality of actions required to continue game play on behalf of said first game participant; and
automatically update a game profile of the first game participant based on the plurality of actions required to continue game play and the event message from a second game participant corresponding to the one or more of a plurality of actions.

10. The article of claim 9 wherein the game play corresponds to a fantasy sports game and the game profile of the first game participant is a roster of game players by position.

11. The article of claim 9, further comprising instructions that when executed enable the system to determine if a game participant has not logged on to game play for a period T.

12. The article of claim 10, further comprising instructions that when executed enable the system to rank a plurality of players by position and compare each of the ranked players to a corresponding player on the roster of the first game participant by position.

13. The article of claim 12, further comprising instructions that when executed enable the system to compare the ranking of the one or more fantasy sports players to corresponding players on a roster of a participant at a same position.

14. The article of claim 13, further comprising instructions that when executed enable the system to determine if the ranked player is on the roster of the first game participant and if the ranked player is on the roster of the first game participant then automatically replace the player on the roster of the first game participant with the ranked player at the corresponding position.

15. The article of claim 13, further comprising instructions that when executed enable the system to determine if the ranked player is on the roster of the first game participant and if the ranked player is not on the roster of the first game participant then automatically propose a trade to the second game participant on which the ranked player is identified as being part of the roster of the second game participant.

16. An apparatus, comprising:
a processor; and
a memory communicatively coupled to the processor, the memory configured to store a game system for execution by the processor, the game system comprising:
a scheduling module operative to determine one or more response deadlines associated with an inactive game participant;
an action items module operative to compare ranked game players with a roster of game players associated with the inactive game participant and if the ranked game player has a higher ranking than one or more roster players associated with the inactive game participant, then replace the one or more roster game players with one or more ranked game players;
a lineup module operative to update the roster of game players associated with the inactive game participant in response to the roster of game players provided by the action items module and within the one or more response deadlines provided by the scheduling module.

17. The apparatus of claim 16 wherein the action items module is operative to send a request from the inactive game participant to a first game participant to trade a ranked player on a roster of the first participant with a player on the roster of the inactive game participant.

18. The apparatus of claim 17 further comprising an event trigger module operative to receive a message from the first participant in response to the trade request sent by the action items module and determine whether or not to propose an additional trade request to the first participant with another player from the roster of the inactive game participant.

19. The apparatus of claim 16, wherein the scheduling module is operative to provide the action item module with information about the availability of one or more players on the roster of the inactive game participant.

20. The apparatus of claim 18 further comprising an interface module operative to communicate with the action items module, the event trigger module, the lineup module and the scheduling module and provide a roster of players associated with the inactive game participant to a game module configured to conduct game play.

21. The apparatus of claim 18 wherein the event trigger module determines if a time for the first participant to respond to a trade request has expired and if the time for the first participant has expired, then the action items module identifies the next ranked player by position and determines if the next ranked player is ranked higher than a corresponding player on the roster of the inactive game participant.
